(19) United States
(12) Patent Application Publication
(10) Pub. No.: US 2023/0043296 A1
(43) Pub. Date: Feb. 9, 2023

(54) APOGI TECH

(71) Applicant: Jesper BENDSEN, Silkeborg (DK)

(72) Inventor: Jesper BENDSEN, Silkeborg (DK)

(21) Appl. No.: 17/968,227

(22) Filed: Oct. 18, 2022

Related U.S. Application Data
(63) Continuation-in-part of application No. 17/460,702, filed on Aug. 30, 2021.
Application No. 17/460,702 is a continuation of application No. PCT/EP2020/081047, filed on Nov. 5, 2020.

(30) Foreign Application Priority Data
Nov. 5, 2019 (DK) 201901293
Nov. 7, 2019 (DK) 201901305
May 8, 2020 (DK) 202000551

(51) Int. Cl. C01B 5/00

(52) U.S. Cl. CPC C01B 5/00

(57) ABSTRACT

A method of producing permanently structured water in which regular water is passed through at least one flow form where at least one modified material being placed sufficiently close thereto. Also, several products based on modified material, such as food, cosmetics, medicals, jewelry, cleaning and radioactivity-reducing product. Furthermore, various uses of a modified material.

### CROSS-REFERENCE TO RELATED APPLICATIONS

This application is a continuation-in-part of U.S. patent application Ser. No. 17/460,702, filed on Aug. 30, 2021, which is a continuation of International Patent Application No. PCT/EP2020/081047, filed on Nov. 5, 2020, which claims priority to Danish Patent Application No. 201901293, filed on Nov. 5, 2019, Danish Patent Application No. 201901305, filed on Nov. 7, 2019, and Danish Patent Application No. 202000551, filed on May 8, 2020.

### FIELD

The present invention relates to a method of producing permanently structured water as well as several products and uses based on modified materials, such as food, cosmetics, medicals, jewelry, cleaning and radioactivity-reducing product.

### SUMMARY

The present inventors have designed a method and device for producing permanently structured water.

In a first aspect the present invention concerns a method of producing permanently structured water, characterized in that regular water is passed through at least one flow form and at least one modified material are placed sufficiently close to where the regular water moves through the at least one flow form.

In one embodiment the at least one modified material is selected from modified fluorite, modified quartz and permanently structured water.

In another embodiment regular water is passed through at least one flow form that is a shaped like a FIG. 8.

In a further embodiment the at least one modified material is placed sufficiently close to where the regular water moves through the flow form so that permanently structured water is produced.

In a still further embodiment the at least one modified material is selected from metals and/or all other conceivable materials that are made modified. Typically, the at least one modified material is selected from among metals and/or carbon materials.

In a further embodiment the at least one modified material is graphite.

In a still further embodiment the at least one modified material is selected from modified crystals.

In a second aspect the present invention also concerns a food product, characterized in that it comprises at least one modified material.

In a further aspect the present invention also concerns a cosmetic product, characterized in that it comprises at least one modified material. In an embodiment the at least one modified material is selected from modified fluorite, modified quartz and permanently structured water.

In a further embodiment the cosmetic product is selected from among creams, deodorants, lotions etc.

In a still further aspect the present invention concerns a medical product, characterized in that it comprises at least one modified material. In an embodiment the at least one modified material is chosen from modified fluorite, modified quartz and permanently structured water.

in a further embodiment the medicinal product is chosen from among blood treatment products, products that changes the electrical potential of the surface of cells, skin treatment products, muscle treatment products, etc.

In a still further aspect the present invention also concerns a jewelry product, characterized in that it comprises at least one modified material. In an embodiment The at least one material is chosen from modified fluorite, modified quartz and permanently structured water.

In a further aspect the present invention concerns a cleaning product, disinfecting product and chemical product, characterized in that it comprises at least one modified material.

In a still further aspect the present invention also concerns a radioactivity-reducing product, characterized in that it comprises at least one modified material.

In a further aspect the present invention concerns use of at least one modified material for the manufacturing of a product chosen from the group consisting of permanently structuring water products, beverage products, food products, feed products, cosmetic products, medical products, jewelry products, cleaning products, disinfecting products, chemical products and a radioactivity reducing product. In an embodiment the at least one modified material is chosen from modified fluorite, modified quartz and permanently structured water.

In a further aspect the present invention concerns a wellness water product, characterized in that it comprises at least one modified material.

In a still further aspect the present invention concerns the use of at least one modified material for the manufacturing of a product chosen from the group consisting of wellness water products. In an embodiment the at least one modified modified material is chosen from modified fluorite, modified quartz and permanently structured water.

In a further aspect the present invention concerns the use of at least one modified material for increasing the shelf-life of a product consisting of permanently structuring water products, beverage products, food products, feed products, cosmetic products, medical products, jewelry products, cleaning products, disinfecting product, chemical products.

In a still further aspect the present invention concerns a drinks product.

In a further aspect the present invention concerns a fruit and/or vegetable.

In a still further aspect the present invention concerns a feed product.

In a further aspect the present invention concerns is a cosmetic and/or a medical product.

In a further embodiment the at least one modified material is chosen from modified fluorite, modified quartz and permanently structured water.

In a further embodiment the at least one modified material is chosen from among metals and/or all other conceivable materials that are made modified.

Further objects and advantages of the present invention will appear from the following description, and claims.

### Definitions

The term “normal fluorite” or “Normal Fluorite” (used interchangeably) as used herein is defined as being products containing fluorite (CaF₂) as well as pure fluorite. Normal Fluorite can be naturally colored as there are other substances and/or minerals contained in the fluorite. It can be found in nature and/or come from mines. It can also be chemically produced.

The term “modified fluorite” or “Modified Fluorite” (used interchangeably) as used herein is defined as being products containing modified Fluorite (CaF₂) as well as pure modified fluorite. Modified Fluorite can be purchased at the website https://apogi.tech/modified-fluorite. Modified Fluorite is manufactured by processing Normal Fluorite in a strong electromagnetic field above 5 GHz for at least 1 hour.

The term “normal crystal” or “Normal Crystal” (used interchangeably) as used herein are defined as being products where the atomic structure is mostly organized in an aligned structure. Normal Crystals are for instance normal fluorite, normal quartz, normal metals etc. Normal Crystals can also be chemically produced.

The term “modified crystal” or “Modified Crystal” (used interchangeably) as used herein are defined as being products where the atomic structure is mostly organized in an aligned structure. Modified Crystals are for instance Modified Fluorite, Modified Quartz, Modified Metals etc. Modified Crystals can be purchased at the website https://apogi.tech/modified-crystals. Modified Crystals are manufactured by processing Normal Crystals in a strong electromagnetic field above 5 GHz for at least 1 hour.

The term “Regular water” as used herein is defined as fluids comprising water such as tap water, sea water, lake water, salt water, rain water etc. The Regular Water can have salts, minerals or even supplements in it. Regular Water is not Permanently Structured Water. Regular Water can be processed into Permanently Structured Water.

The term “Flow form” or “flowform” (used interchangeably) as used herein is defined as an object which Regular water runs through and/or over and which causes the water to move in certain movements and/or patterns and/or whirls that make the regular water into structured water. All objects which can make regular water structured are defined as a flowform.

Permanently structured water has an oxygen down take rate and/or an oxygen uptake rate that is shorter (quicker in time) than Regular Water and/or a cooler surface area temperature than Regular Water as measured as described in the paragraph ‘Measuring Methods for Permanently Structured Water’.

The term “Modified Material” or “modified material” (used interchangeably) as used herein is defined as being selected from the group consisting of Modified Fluorite and Modified Quartz and Modified Crystals and Permanently Structured Water.

The term “PSW Unit” or “Permanent Structuring Water Unit” (used interchangeably) as used herein is defined as a machine or a construction which can produce permanently structured water. The machine comprises at least one flowform and comprises modified fluorite and/or other modified materials as described herein.

The term “food/drink/irrigation products” as used herein are defined as food products and drink products for humans and animals, as well as irrigation products for plants and crops.

The term “food products” as used herein for animals can also be referred to as feed.

### BRIEF DESCRIPTION OF DRAWINGS

FIG. 1 illustrates a flowform holder which is to be filled with a liquid, such as Regular Water.

FIG. 2 illustrates a flowform according to the invention.

FIG. 3 illustrates another flowform according to the invention.

### DESCRIPTION

Overall, the invention concerns a method in which modified materials is used to produce permanently structured water that can be used, without limitation, in food/drink/irrigation products, feed products, cosmetic products, medical products, jewelry products, cleaning products, disinfecting products, chemical products and radioactivity-reducing products.

This section and all sub-section describe forms of embodiment and/or forms of use for all claims in the patent. Patent claims that are not specifically referred to in a sub-section may therefore be indirectly covered or implied and covered by the detailed descriptions.

### A Method of Producing Permanently Structured Water

An aspect of the present invention relates to a method of producing permanently structured water, characterized in that Regular Water is passed through at least one flow form and modified materials are placed sufficiently close to where the Regular Water moves through the flowform. Typically, the modified materials are selected from modified fluorite, modified quartz and permanently structured water.

A further aspect of the present invention concerns a method of producing permanently structured water, characterized in that Regular Water is passed through at least one flowform that is a shaped like a FIG. 8 (the integer eight). Typically, the modified materials are placed sufficiently close to where the Regular Water moves through the flow form so that permanently structured water is produced.

The invention will now be described more fully with reference to the appended drawings illustrating typical embodiments of the invention. These drawings are by no means limiting the scope of the present invention and are only intended to guide the skilled person for better understanding of the present invention.

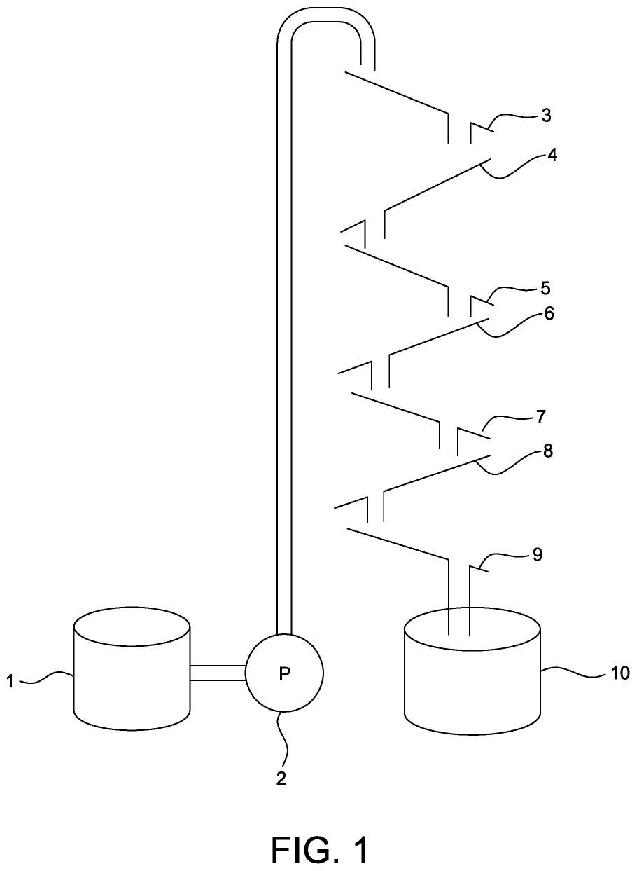

The PSW UNIT machine is shown in FIG. 1. It consists of 7 flowforms and modified material located sufficiently close to the place in each individual flowform where the Regular Water is whirled most, without disturbing the whirl itself. The PSW UNIT has approximately 50 grams of modified material, being Modified Fluorite, located 1 cm from the whirl in each flowform. At least one flowform is required in the PSW UNIT.

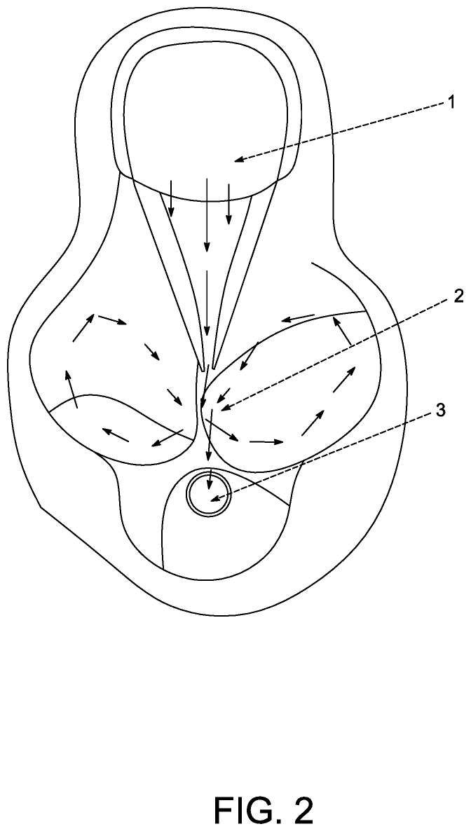

The flowforms which were used moved the Regular Water in integer 8 movements, shown in FIG. 2, but flowforms might as well have been used that moved the Regular Water in whirls. Both kinds of flowform create whirls where the Regular Water collides with itself.

A PSW UNIT could also be constructed of a long Regular Water hose that folds in integers of 8 on top of each other where modified materials are located sufficiently close to the middle of all integers of 8.

The modified fluorite that is used could just as easily be replaced by other modified materials such as modified quartz, or other modified crystals.

The modified fluorite referred to in this document is purchased on the website https://apogi.tech/modified-fluorite or is made as described herein.

### Method 1 to Produce Permanently Structured Water

For the experiment, 7 flowforms were used that were placed vertically on top of a stand. Each flowform had an inlet at the top and an outlet at the bottom. They were placed in such a way on the stand that the Regular Water ran into the upper flowform and down through all flowforms and out at the bottom of the lower most flowform. The flowform wall forms used in this experiment were called Glonn 80′ Polymer Skin and were purchased at www.flowform.net.

The flowforms each moved the Regular Water in an integer of 8 movement. On the backside of the form of each flowform wall modified fluorite was placed in the middle of the integer of 8 movement. The modified fluorite was purchased at the following website https://apogi.tech/modified-fluorite or is made as described herein.

FIG. 1 shows a flowform holder (1) which was filled with approximately 240 liters of Regular Water. The electric pump (2) was then started so that the Regular Water was pumped into the upper flow form (3) at a rate of approximately 80 liters of Regular Water per minute. From the top flowform, the Regular Water circulated down through the underlying flowforms (4, 5, 6, 7, 8, 9) and down to a flowform holder (10). The pump (2) operated for about 3 minutes, then it was turned off.

FIG. 2 point 1 is where the Regular Water flows into the flowform, and point 3 is where the Regular Water flows out of the flowform. Point 2 is where the modified fluorite was placed directly on the back of the flowform and where the Regular Water meets when it moves in integer of 8 movements.

### Method 2 to Produce Permanently Structured Water

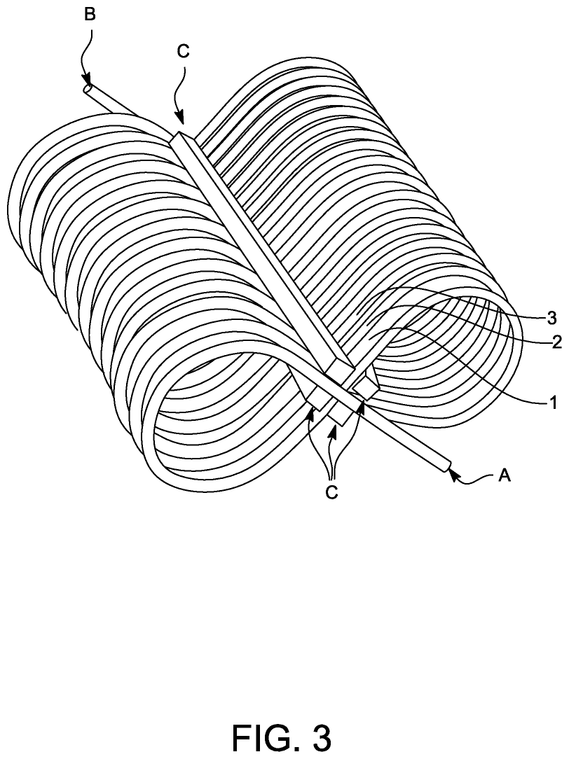

In this test, an integer of 8 flowform as shown in FIG. 3 was used. The flowform had 21 integers of 8 but had also worked if it had only had one integer of 8 flowform.

Point A is where the Regular Water flowed into the flowform. Point B is where the Regular Water flowed out of the flowform.

Point 1, 2 and 3 are where air was pumped into the flowform. Enough air was pumped into the flowform so that the oxygen saturation in the Regular Water was at least 100%. The Regular Water would still have become permanently structured water if no oxygen had been added.

Point C are the 4 elongated square tubes which contain modified fluorite. Each tube was just as long as the integer of 8 flowform itself, and each tube contained approximately 1.5 kg of modified fluorite. The pipes were located close to the center of each integer of 8 flowform. The modified fluorite was purchased at the following website https://apogi.tech/modified-fluorite or is made as described herein.

Any other modified materials could have been used here.

The water used in this experiment was Regular Water from a reverse osmosis system. Regular Water from a tap could also have been used.

The end result was that the Regular Water became permanently structured water.

If the 4 square pipes, point C, had not been filled with a modified material, or the pipes were not present, the Water coming out of point B would have been Regular Water, but not permanently structured water.

### Food Products and Their Uses

In a further aspect the present invention relates to a food product, characterized in that it comprises modified materials.

In a still further aspect, the present invention relates to use of modified materials for increasing the shelf-life of a product selected from food products.

Permanently structured water can be fully or partially incorporated into drinking water, water to irrigate crops, plants and fields, drinks in general, foods, feeds, juices, wine, beer, milk, soft drinks and alcoholic drinks.

Modified materials can be fully or partially incorporated into the physical environments where foods and/or feeds and/or crops are stored. The effect is that the shelf life of foods and/or feeds and/or crops is increased compared to if modified materials were not present and/or placed close enough to them.

### Use in Drink Products and Juices

Use can take place through mixing permanently structured water into drink products, or through the drink itself consisting solely of permanently structured water. Through the permanently structured water, all products will have better properties, which is understood to mean that what the individual products were intended to achieve is improved and/or can last longer. Thus, some drinks/foods will have a better taste and/or longer shelf life.

If permanently structured water is mixed into juices, vegetables and/or fruits will have a more intensive and better taste and for a longer time than if no permanently structured water were mixed in. The permanently structured water can make up as little as 1-5% volume of the juice. Another effect is that the juice's shelf life is extended from about 3 days to about 6 days or more, and the taste is fresh and uniform on all the days.

### Use for Cows

In several places in Denmark, farmers have problems with the fact that their livestock will not drink the Regular Water coming from the municipal water system via the water pipe leading up to their farm. There is a strong suspicion that this may be due to electromagnetic fields, currents and voltages from high voltage power lines and/or from wind turbines and/or from frequency-controlled water pressure pumps that leave an electromagnetic signature in the water that is perceived as unpleasant for livestock. The suspicion has arisen because many of the farmers with these problems have had the current voltages measured in their drinking water.

We therefore tested a PSW UNIT set up on a farm with cows where it could be observed that the cows were not happy to drink the water because they were below normal for the amount of milking's per day.

After 3 weeks of testing, the data showed an increase in milk production of 8.3% volume and an increase in the amount of milking's of 7.9% due to the cows only drinking water treated with the PSW UNIT.

### Use for Plants and Crops

By using permanently structured water to water crops in agriculture, plants will always receive the necessary energy they need to be able to grow and develop optimally.

When foods and/or feeds and/or crops are stored sufficiently close enough to modified materials, their shelf life will increase.

Test with the Shelf Life of Tomatoes

We carried out a test on organic tomatoes where we could see that in the case of the tomatoes where enough modified materials were present and sufficiently close to the tomatoes, the shelf life increased to such an extent that they were still edible after a period of 38 days. In the case of tomatoes without the influence of permanently structured water, approximately 40-50% of their mass rotted away after a period of 38 days. In the experiment, 15 grams of permanently structured water was placed a few centimeters away from 2 organic tomatoes, referred to as set-up A. Placed 8 meters away from line A, were another 2 organic tomatoes and no permanently structured water, referred to as set-up B. The 4 organic tomatoes were bought at the local supermarket in the same packaging.

After 38 days there was only a little wrinkling to see on the tomatoes at set-up A. At setup B, approximately 40-50% of the mass of tomatoes had disappeared and it was clear to see that they were rotten.

Cosmetic Products and their Uses

In a further aspect, the present invention relates to a cosmetic product, characterized in that it comprises at least one modified material. Typically, the modified material is selected from among modified fluorite, modified quartz and permanently structured water. Typically, the product is chosen from among creams, deodorants, and/or lotions.

Further aspects of the invention relate to use of modified materials for increasing the shelf-life of a product selected from cosmetic products.

When permanently structured water and/or modified materials are mixed into creams and applied to skin, the skin and skin cells will receive energy that ends up building up the electrical potential on the surface of cells and/or energy level of cells in general.

Cosmetic products will have a better effect and/or longer shelf life and/or provide energy to the user.

### Use in Cosmetics

10 containers of ordinary L'Oréal 50 ml day cream were purchased which were mixed with 5 grams of powdered modified fluorite in each cream. This is equivalent to 10% volume modified fluorite. It was then applied to the face in a normal layer in 10 subjects.

The perception of the test subjects was that they gained more energy, felt more awake, had more vitality and energy, and had more colour and blood flow in the face.

Several of the test subjects had mosquito bites that itched, and when they applied the cream, they found that the mosquito bites stings stopped itching.

Several of the subjects had small scratches and wounds; they applied the cream over a few days and experienced that scratches and wounds healed faster than normal.

We found that if we used between 5% volume and 10% volume modified fluorite in the cream, the subjects gained more energy, felt more awake, had more vitality and energy, and had more colour and blood flow in the face.

### Medical Products and Their Use

In a still further aspect, the present invention relates to a medical product, characterized in that it comprises at least one modified material. Typically, the modified material is selected from among modified fluorite, modified quartz and permanently structured water. Typically, the product is chosen from among blood treatment products, a product that changes the electrical potential of the surface of cells, skin treatment products, muscle treatment products, etc.

In a further aspect the present invention relates to use of modified materials for increasing the shelf-life of a product selected from medical products.

As described above applications where modified fluorite affects blood, modified fluorite can be used to treat blood. In the study, it is apparent that the result of the effect of modified fluorite on the red blood cells is that they can now move freely between each other and no longer clump together. The modified fluorite and permanently structured water have the same properties and effects, so it is evident to assume that the permanently structured water will have the same effect whether it lies on the body or whether it is ingested orally.

Without being bound by theory, we have indications that what happens is that the electrical potential on the surface on the red blood cells is recharged, which is why there is now an electrical charge that allows the red blood cells to electrically repel each other so that they can individually move freely between each other.

The effect that can be seen on the red blood cells can clearly be assumed to happen on all cells whether it is in blood or not. The right electrical potential on the surface on cells in general is essential for various nutrients, signaling agents and waste materials to pass in and out of the cell. And the permanently structured water and/or modified fluorite has the effect on cells that the electrical potential on the surface of cells is restored and/or rebuilt.

Blood treatment products improve and or/repair the cells in the blood by taking in the permanently structured water orally, intravenously or applying it to the skin.

Skin and/or wound treatment products provide more energy to the skin and/or restore healthy skin and/or heal the skin faster than if the product is not used. See “Uses where modified fluorite heals wounds”.

Because the technology builds up the electrical potential on the surface on cells in general, the functioning of cells generally improves for the better. It is therefore to be expected that stress on the body at a macro level will be reduced. This means that it is expected that if stress blood markers are measured it will be seen that they have become lower.

### Uses Where Modified Fluorite Affects Blood

A test subject came to the Holmes Health clinic in LA. She had a drop of blood collected here and blood microscopy was performed on the drop of blood. Under the microscope it could be seen that many of her red blood cells had clumped together.

She then had approximately 15 grams of modified fluorite place on the top of her head, on her forehead, on her neck, chest, on the solar plexus, on the abdomen and at the end of the lower part of the spine. She lay on her back for around 15 minutes. All in all, approximately 105 grams of modified fluorite. She neither drank, ate, or went to the toilet during the test.

She then had another drop of blood taken, and the same blood microscopy was performed again.

The result was that all her red blood cells were now not lumped together but moved quickly and freely between each other.

### Uses Where Modified Fluorite Heals Wounds

One test subject had had a permanent wound for 5 years around her stoma bag hole in the skin. We placed a bag of about 15 grams of modified fluorite close to the stoma hole around the clock. Within approximately one week her wound had healed completely.

Subsequently, she lost the bag with the approximately 15 grams of modified fluorite in it. And within a week, her wound was back again. She was then given another bag with about 15 grams of modified fluorite in it and again within about 1 week her stoma wound healed again.

### Jewelry Products and Their Use

In a still further aspect, the present invention relates to a jewelry product, characterized in that it comprises at least one modified material. Preferably, the modified material is selected from among modified fluorite, modified quartz and permanently structured water.

### Use of Modified Fluoride for Jewelry

Modified fluorite can be cut, ground and polished and included in rings, hairbands, bracelets, necklaces, ornaments and in jewelry in general.

Cleaning Products, Disinfecting Products and Chemical Products and their Uses

In a further aspect the present invention relates to a cleaning product, disinfecting product and chemical product, characterized in that it comprises at least one modified material.

In a still further aspect, the present invention relates to use of modified materials for increasing the shelf-life of a product selected from cleaning products.

In a further aspect the present invention relates to use of modified materials for increasing the shelf-life of a product selected from disinfecting products.

In a still further aspect, the present invention relates to use of modified materials for increasing the shelf-life of a product selected from chemical products.

Because permanently structured water and a modified material are able to improve drink products, food products, feeds, blood etc. etc. it is likely that it will also be able to improve cleaning products, disinfecting products and chemical products. The improvement will highly probably be that cleaning products, disinfecting products and chemical products can be diluted with permanently structured water and/or a modified material and still have the same efficiency.

### Radioactivity-Reducing Product and its Use

In a further aspect the present invention relates to a radioactivity-reducing product, characterized in that it comprises at least one modified material.

Permanently structured water and a modified material are able to improve drink products, food products, feeds, blood, cosmetics, cleaning products, disinfecting products and chemical products by bringing the products back into a highly stable energy state. Therefore, it is likely that via permanently structured water and/or a modified material, radioactive substances can be brought into a stable state more quickly than normal.

### Wellness Water Product and its Use

In a further aspect the present invention relates to a wellness water product, characterized in that it comprises at least one modified material.

Permanently structured water and a modified material are able to improve the water quality of pools, swimming pools, spas and floating tanks for human beings and animals Water in pools, swimming pools, spas and floating tanks can be fully or partially replaced by permanently structured water and/or modified materials can be added into pools, swimming pools, spas and floating tanks.

Humans and animals will experience a better sense of calm and well-being when the water in pools, swimming pools, spas and floating tanks has had modified materials added to it. This is because the modified materials charge the water with more energy. For a pool with 45,000 litres of water, 1 kg modified fluorite can be placed on the bottom or in the skimmer. People will then feel that there is more energy in the water. This means that there is a greater feeling of calm and well-being than if 1 kg of modified fluorite had not been added to the water.

The water in pools, swimming pools, spas and floating tanks can also be treated with the PSW UNIT after which it will become permanently structured water. This means that there is a greater feeling of calm and well-being than if the water had not been treated with the PSW UNIT.

### Measuring Methods for Permanently Structured Water

This section describes measurement methods for measuring whether water is permanently structured water or not. Water that is tested to be permanently structured water according to one or more of the measurement methods described in this section is permanently structured water.

### Oxygen Uptake Rate Measurement Method for Permanently Structured Water

Test water is tested for whether it is permanently structured water with the following method.

Test water and regular water are placed in separate vacuum chambers without air until both oxygen percentages are below 10%. Then they are both taken out of the vacuum chamber and both oxygen uptake rates are measured. If the test water has an oxygen uptake rate that is shorter (quicker in time) than ordinary water, then boil and condense the test water. The boiled or boiled condensed test water can be left for 72 hours before continuing the test method. Then the boiled or boiled condensed test water is placed again in a vacuum chamber without air until the oxygen percentage in the boiled or boiled condensed test water has an oxygen percentage below 10%. Then the boiled or boiled condensed test water is taken out of the vacuum chamber and the oxygen uptake rate is measured. If the boiled or boiled condensed test water still has an oxygen uptake rate that is shorter (quicker in time) than the regular water, the test water is deemed permanently structured water.

In above experiment 5 ml of test water and 5 ml of regular tap water was used and the same size containers.

This test can also be done without boiling the water, ie. If the test water, without being boiled, has an oxygen uptake rate that is shorter (quicker in time) than the regular water, the test water is deemed permanently structured water.

### Oxygen Release Rate Measurement Method for Permanently Structured Water

Test water is tested for whether it is permanently structured water with the following method.

Test water and regular water are placed in separate vacuum chambers and air is removed until both oxygen percentages are below 10%. The oxygen release rate is measured. If the test water has an oxygen release rate that is shorter (quicker in time) than regular water, then boil and condense the test water. The boiled or boiled condensed test water can be left for 72 hours before continuing the test method. Then the boiled or boiled condensed test water is placed again in a vacuum chamber and air is removed until the oxygen percentage is under 10%. If the boiled or boiled condensed test water still has an oxygen release rate that is shorter (quicker in time) than the regular water, the test water is deemed permanently structured water.

In above experiment 5 ml of test water and 5 ml of regular tap water was used.

This test can also be done without boiling the water, ie. If the test water, without being boiled, has an oxygen uptake rate that is shorter (quicker in time) than the regular water, the test water is deemed permanently structured water.

### Oxygen Down Take Rate and Uptake Rate Experiment

We took 1 sample of 5 ml reverse osmosis water and 1 sample of 5 ml reverse osmosis water passed through a PSW unit selected from any one of the embodiments of FIGS. 1-3. Both samples were placed on top of 2 identical dissolved oxygen O2 meter in a 20 mm diameter container with the height of 50 mm and placed in a vacuum tank. We then emptied the vacuum tank down to 0.05 bar and once the O2 saturation reached 20% we let the air back into the tank. We monitored the O2 down take time rate and O2 uptake time rate.

We repeated and measured 6 times that the 5 ml reverse osmosis water passed through a PSW unit oxygen down take rate from apx. 90% to 20% took 150 to 300 seconds. The speed is apx. 21-42 seconds per 10% decrease. The oxygen uptake rate from apx. 20% to 60% for the 6 times repeated took apx. 10 seconds per 10% increase.

We repeated and measured 8 times that the 5 ml reverse osmosis water oxygen down take rate from apx. 90% to 20% took 900 to 4000 seconds. The speed is apx. 350 seconds per 10% decrease. The oxygen uptake rate from apx. 20% to 60% for the 8 times repeated took apx. 1500 seconds per 10% increase.

In this experiment the reverse osmosis water passed through a PSW unit had an oxygen down take rate that was apx. 8 to 16 times quicker compared to the reverse osmosis oxygen down take rate. And the reverse osmosis water passed through a PSW unit had an oxygen uptake rate that was apx. 150 times quicker compared to the reverse osmosis oxygen uptake rate.

### Oxygen Uptake Rate Calculated and Conclusion

The calculated uptake rate for water from apx. 20% to 60% is apx. 5400 seconds for 10% increase. The reverse osmosis water speed is 1500 seconds per 10% increase. The reverse osmosis water passed through a PSW unit speed is 10 seconds per 10% increase. The conclusion is that even the reverse osmosis water is 4 times quicker than calculated uptake rate, and that the reverse osmosis water passed through a PSW unit is 540 times quicker, leaving a huge significance in difference.

### Infrared Measurement Method for Permanently Structured Water

Test water is tested for whether it is permanently structured water with the following method.

With an infrared camera, a picture is taken of the water surface of an open container with test water and of the water surface of another open container with regular water. The two containers may be separated by a salt barrier If the water surface of test water has a surface temperature that is colder than the water surface with regular water, the test water is boiled, and the water vapor is condensed. The boiled or boiled condensed test water can be left for 72 hours before continuing the test method. Then, with an infrared camera, a picture is taken of the water surface of an open container with the boiled or boiled condensed test water and of the water surface of the open container with regular water. The two containers may be separated by a salt barrier. If the water surface of the boiled or boiled condensed test water has a surface temperature that is still colder than the water surface with regular water, the test water is deemed permanently structured water.

This test can also be done without boiling the water, ie. If the water surface of test water has a surface temperature that is still colder than the water surface with regular water, the test water is deemed permanently structured water.

All references, including publications, patent applications and patents, cited herein are hereby incorporated by reference to the same extent as if each reference was individually and specifically indicated to be incorporated by reference and was set forth in its entirety herein.

All headings and sub-headings are used herein for convenience only and should not be construed as limiting the invention in any way.

Any combination of the above-described elements in all possible variations thereof is encompassed by the invention unless otherwise indicated herein or otherwise clearly contradicted by context.

Recitation of ranges of values herein are merely intended to serve as a short method of referring individually to each separate value falling within the range, unless otherwise indicated herein, and each separate value is incorporated into the specification as if it were individually recited herein. Unless otherwise stated, all exact values provided herein are representative of corresponding approximate values (e.g., all exact exemplary values provided with respect to a particular factor or measurement can be considered to also provide a corresponding approximate measurement, modified by “about”, where appropriate).

All methods described herein can be performed in any suitable order unless otherwise indicated herein or otherwise clearly contradicted by context.

The terms “a” and “an” and “the” and similar referents as used in the context of de-scribing the invention are to be construed to insert both the singular and the plural, unless otherwise indicated herein or clearly contradicted by context. Thus, “a” and “an” and “the” may mean at least one, or one or more.

The term “and/or” as used herein is intended to mean both alternatives as well as each of the alternatives individually. For instance, the expression “xxx and/or yyy” means “xxx and yyy”; “xxx”; or “yyy”, all three alternatives are subject to individual embodiments.

The use of any and all examples, or exemplary language (e.g., “such as”) provided herein, is intended merely to better illuminate the invention and does not pose a limitation on the scope of the invention unless otherwise indicated. No language in the specification should be construed as indicating any element is essential to the practice of the invention unless as much is explicitly stated.

The citation and incorporation of patent documents herein is done for convenience only and does not reflect any view of the validity, patentability and/or enforceability of such patent documents.

The description herein of any aspect or embodiment of the invention using terms such as “comprising”, “having”, “including” or “containing” with reference to an element or elements is intended to provide support for a similar aspect or embodiment of the invention that “consists of”, “consists essentially of”, or “substantially comprises” that particular element or elements, unless otherwise stated or clearly contradicted by context (e.g., a composition described herein as comprising a particular element should be understood as also describing a composition consisting of that element, unless otherwise stated or clearly contradicted by context).

This invention includes all modifications and equivalents of the subject matter re-cited in the aspects or claims presented herein to the maximum extent permitted by applicable law.

The features disclosed in the foregoing description may, both separately and in any combination thereof, be material for realizing the invention in diverse forms thereof.

We claim:

1. A method of producing permanently structured water, wherein regular water is passed through at least one flow form and at least one modified material are placed sufficiently close to where the regular water moves through the at least one flow form.

2. The method according to claim 1, wherein the at least one modified material is selected from modified fluorite, modified quartz and permanently structured water.

3. The method according to claim 1, wherein regular water is passed through at least one flowform that is a shaped like a FIG. 8.

4. The method according to claim 1, wherein the at least one modified material is placed sufficiently close to where the regular water moves through the flow form so that permanently structured water is produced.

5. The method according to claim 1 wherein the at least one modified material is selected from metals and/or all other conceivable materials that are made modified.

6. The method according to claim 5, wherein the at least one modified material is selected from among metals and/or carbon materials.

7. The method according to claim 6, wherein the at least one modified material is graphite.

8. The method according to claim 1, wherein the at least one modified material is selected from modified crystals.
